(19) United States
(12) Patent Application Publication
(10) Pub. No.: US 2015/0321942 A1
(43) Pub. Date: Nov. 12, 2015

(54) CUTTING METHOD FOR GLASS SUBSTRATE, GLASS SUBSTRATE, NEAR-INFRARED CUT FILTER GLASS, MANUFACTURING METHOD FOR GLASS SUBSTRATE

(71) Applicant: Asahi Glass Company, Limited, Tokyo (JP)

(72) Inventors: Hidetaka MASUDA, Tokyo (JP); Yoshiki Obana, Tokyo (JP); Kazuhide Kuno, Haibara-gun (JP)

(73) Assignee: Asahi Glass Company, Limited, Tokyo (JP)

(21) Appl. No.: 14/803,639

(22) Filed: Jul. 20, 2015

Related U.S. Application Data
(63) Continuation of application No. PCT/JP2014/052421, filed on Feb. 3, 2014.

(30) Foreign Application Priority Data
Feb. 4, 2013 (JP) 2013-019442

(51) Int. Cl. C03B 33/02; B23K 26/40; C03C 3/17; B23K 26/00

(52) U.S. Cl. CPC C03B 33/0222; B23K 26/0057; B23K 26/4075; C03C 3/17

(57) ABSTRACT

To provide a cutting method for a glass substrate which can be easily cut by efficiently forming a modified region inside the glass substrate, a glass substrate, and a near-infrared cut filter glass. The cutting method for a glass substrate according to the present invention includes the steps of: radiating light to be focused inside a glass substrate to selectively form a modified region inside the glass substrate; and causing a crack in a thickness direction of the glass substrate starting from the modified region and cutting the glass substrate along the modified region, in which the glass substrate has a fracture toughness of 0.1 MPa·m^{1/2} to 0.74 MPa·m^{1/2}.

### CROSS-REFERENCE TO RELATED APPLICATIONS

This application is a continuation of prior International Application No. PCT/JP2014/052421 filed on Feb. 3, 2014 which is based upon and claims the benefit of priority from Japanese Patent Application No. 2013-019442 filed on Feb. 4, 2013; the entire contents of all of which are incorporated herein by reference.

### FIELD

The present invention relates to a cutting method for a glass substrate, a glass substrate, a near-infrared cut filter glass, and a manufacturing method for a glass substrate.

### BACKGROUND

As a cutting method for a semiconductor substrate or the like, Stealth Dicing (registered trademark) is known. In this cutting method, first, laser light with a wavelength passing through the semiconductor substrate (for example, silicon (Si)) is collected inside the semiconductor substrate to form a modified region (flaw region). Then, in the above-described cutting method, an external stress such as a tape expansion is applied to cause a crack in the semiconductor substrate starting from the modified region and cut the semiconductor substrate.

In the above-described cutting method, it is possible to locally and selectively form the modified region inside the semiconductor substrate without damaging the surface of the semiconductor substrate and therefore reduce occurrence of defects such as chipping and the like on the surface of the semiconductor substrate which is a problem in general blade dicing. In addition, there are fewer problems such as dust occurrence and so on unlike machining. Therefore, in recent years, the above-described cutting method becomes to be widely used not only in cutting the semiconductor substrate but also in cutting a glass substrate.

### SUMMARY

When the glass substrate is cut using the laser light as described above, the laser light is used to scan a planned cutting line to thereby form a modified region inside the glass substrate. However, if the size of a crack occurring from the modified region formed by the laser light is small, there is a worry that, at the time of making the glass substrate into pieces along the planned cutting line starting from the modified region, the glass substrate cannot be reliably cut. Further, even if the size of the crack occurring from the modified region formed by the laser light is appropriate, the cut surface of the glass substrate becomes rough, the dimensional accuracy deteriorates, and chipping becomes more likely to occur from the cut surface, unless the crack extends in a plate thickness direction of the glass substrate at the time of making the glass substrate into pieces along the planned cutting line starting from the modified region. Further, when the cut surface of the glass substrate becomes rough, the bending strength of the glass substrate is decreased.

The present invention has been made to solve the above problems and its object is to provide a cutting method for a glass substrate which can be easily cut and has a high bending strength by efficiently forming a modified region inside the glass substrate, a glass substrate, a near-infrared cut filter glass, and a manufacturing method for a glass substrate.

A cutting method for a glass substrate according to the present invention includes the steps of: radiating light to be focused inside a glass substrate to selectively form a modified region inside the glass substrate; and causing a crack in a thickness direction of the glass substrate starting from the modified region and cutting the glass substrate along the modified region, in which the glass substrate has a fracture toughness of 0.1 MPa·m^{1/2} to 0.74 MPa·m^{1/2}.

According to the present invention, it is possible to easily cut a glass substrate by efficiently forming a modified region therein.

### BRIEF DESCRIPTION OF THE DRAWINGS

FIG. 1 is a side view of a glass substrate according to an embodiment.

FIG. 2 is a schematic view of a glass substrate cutting apparatus according to the embodiment.

FIG. 3 is an explanatory view at the time of cutting the glass substrate according to the embodiment.

FIGS. 4A to 4C are explanatory views of the cutting method for the glass substrate according to the embodiment.

FIG. 5 is a cross-sectional view illustrating an example in which the glass substrate according to the embodiment is used for an imaging apparatus.

### DETAILED DESCRIPTION

Hereinafter, an embodiment will be described referring to the drawings.

### Embodiment

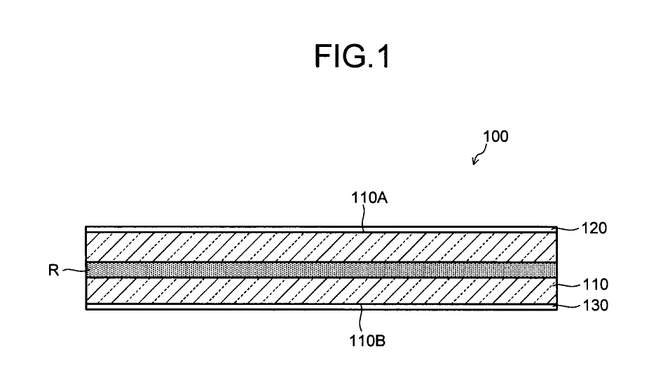

FIG. 1 is a side view of a glass substrate 100 according to an embodiment. As illustrated in FIG. 1, the glass substrate 100 according to the embodiment is, for example, optical glass such as a near-infrared cut filter. The glass substrate 100 includes: a transparent substrate 110; an optical thin film 120 as an anti-reflection film provided on a front surface 110A (light transmitting surface) of the transparent substrate 110; and an optical thin film 130 as a UVIR cut film that cuts an ultraviolet (UV) ray and an infrared (IR) ray provided on a rear surface 110B (light transmitting surface) of the transparent substrate 110.

The near-infrared cut filter is used for a color correction filter for correcting visibility, and is required to efficiently transmit light within a visible light range of a wavelength of 400 to 600 nm and be excellent in sharp cut characteristics near 700 nm.

(Transparent Substrate 110)

The transparent substrate 110 is glass and has a cut surface cut along a modified region R selectively formed by laser light radiated to be focused therein. The transparent substrate 110 preferably has a fracture toughness in a range of 0.1 MPa·m^{1/2} to 0.74 MPa·m^{1/2}. Further, the transparent substrate 110 preferably has an average thermal expansion coefficient in a temperature range of 50 to 300° C. in a range of 65×10⁻⁷/K to 200×10⁻⁷/K. Furthermore, the transparent substrate 110 preferably has a glass transition point (Tg) in a range of 300° C. to 500° C.

Note that the modified region R means a region where some kind of property change has occurred inside the transparent substrate 110 due to irradiation with laser light L. Further, the region where some kind of property change has occurred means a region where embrittlement, phase change (change between melting and solidification), or change in crystal structure has occurred or a region where optical (for example, refractive index or the like) change has occurred, between before and after the irradiation with the laser light L. Therefore, after the modified region R is formed in the transparent substrate 110, cracks may occur starting from the modified region R, but the cracks are not included in the modified region R. Further, the modified region R is preferably formed only inside the transparent substrate 110 without reaching the surface of the transparent substrate 110.

When the fracture toughness of the transparent substrate 110 is more than 0.74 MPa·m^{1/2}, cracks are unlikely to occur from the modified region R at the time of forming the modified region R in the transparent substrate 110 by the laser light L, resulting in difficulty in cutting the glass substrate 100. Further, at the time of cutting the glass substrate 100 starting from the modified region R, the cracks are unlikely to extend in a plate thickness direction, so that the glass substrate 100 is forcedly cut, resulting in a rough cut surface of the glass substrate 100 and a decreased dimensional accuracy. Further, even if the cracks occurring from the modified region R are formed to be large so as to sufficiently extend, cracks extending in directions other than the plate thickness direction also become large, resulting in a rough cut surface of the glass substrate 100. This may decrease the dimensional accuracy and the bending strength of the glass substrate 100.

On the other hand, when the fracture toughness of the transparent substrate 110 is less than 0.1 MPa·m^{1/2}, cracks are likely to occur from the modified region R at the time of forming the modified region R in the transparent substrate 110 by the laser light L. Therefore, cracks starting from the modified region R of the glass substrate 100 and reaching the surface of glass substrate 100 or the transparent substrate 110 are formed, and cracks extending in directions other than the plate thickness direction also become large, bringing about a problem that the cut glass substrate 100 chips to become fragile. Further, even if cracks are formed to be small so as not to form into cracks starting from the modified region R and reaching the surface of glass substrate 100 or the transparent substrate 110, the cracks which have occurred starting from the modified region R are likely to excessively extend. Therefore, cracks extend also in directions other than the plate thickness direction, resulting in a rough cut surface of the glass substrate 100. This may decrease the dimensional accuracy and the bending strength of the glass substrate 100. Further, when the fracture toughness is less than 0.1 MPa·m^{1/2}, cracks existing in the cut surface of the glass substrate 100, even if minute, cause breakage, so that the glass substrate 100 after cutting may have a bending strength not enough for practical use.

The fracture toughness of the transparent substrate 110 is particularly preferably in a range of 0.15 MPa·m^{1/2} or more to 0.65 MPa·m^{1/2} or less, more preferably in a range of 0.2 MPa·m^{1/2} or more to 0.6 MPa·m¹² or less, and further more preferably in a range of 0.2 MPa·m^{1/2} or more to 0.5 MPa·m^{1/2} or less.

Further, when the average thermal expansion coefficient of the transparent substrate 110 in the temperature range of 50 to 300° C. is more than 200×10⁻⁷/K, cracks occurring from the modified region R at the time of forming the modified region R in the transparent substrate 110 by the laser light L are formed too large, resulting in significant decrease in dimensional accuracy and bending strength of the glass substrate 100 after cutting. On the other hand, when the average thermal expansion coefficient of the transparent substrate 110 in the temperature range of 50 to 300° C. is less than 65×10⁻⁷/K, cracks are unlikely to occur from the modified region R at the time of forming the modified region R in the transparent substrate 110 by the laser light L, resulting in difficulty in cutting the glass substrate 100.

The average thermal expansion coefficient of the transparent substrate 110 in the temperature range of 50° C. or higher to 300° C. or lower is preferably in a range of 75×10⁻⁷/K or more to 180×10⁻⁷/K or less, more preferably in a range of 90×10⁻⁷/K or more to 150×10⁻⁷/K or less, and further more preferably in a range of 110×10⁻⁷/K or more to 140×10⁻⁷/K or less.

Further, when the glass transition point (Tg) of the transparent substrate 110 is higher than 500° C., the modified region R itself is unlikely to be formed at the time of forming the modified region R in the transparent substrate 110 by the laser light, resulting in difficulty in cutting the glass substrate 100. On the other hand, when the glass transition point (Tg) of the transparent substrate 110 is lower than 300° C., the modified region R itself becomes too large at the time of forming the modified region R in the transparent substrate 110 by the laser light, resulting in significant decrease in dimensional accuracy and bending strength of the glass substrate 100 after cutting.

In order to set the fracture toughness of the transparent substrate 110 to 0.2 MPa·m^{1/2} to 0.74 MPa·m^{1/2}, set the average thermal expansion coefficient in the temperature range of 50 to 300° C. to 65×10⁻⁷/K to 200×10⁻⁷/K, and set the glass transition point (Tg) to 300° C. to 50° C., the transparent substrate 110 is preferably a fluorophosphoric acid-based or phosphoric acid-based glass substrate.

At the time of forming the modified region R in the transparent substrate 110 using the laser light L, it is preferable that the glass substrate 100 can be cut under a condition of a low total input energy of the laser light L. More specifically, when the total input energy is large at the time of forming the modified region R by the laser light L, cracks remaining in an end surface of the transparent substrate 110 may become large, resulting in decrease in bending strength of the glass substrate 100. Using the transparent substrate 110 having the defined fracture toughness or average thermal expansion coefficient as described above makes it possible to cut the glass substrate 100 under a condition of a low total input energy of the laser light L. Therefore, the glass substrate 100 with less damage on the end surface of the transparent substrate 110 and with high bending strength can be obtained.

In the case of the fluorophosphoric acid-based glass substrate, the transparent substrate 110 preferably contains, in cation %,

P⁵⁺ 20 to 45%,

Al³⁺ 1 to 25%,

R⁺ 1 to 30% (where R⁺ is at least one of Li⁺, Na⁺, K⁺, and the value indicated on the left is a value obtained by adding their respective content ratios),

Cu²⁺ 1 to 15%, and

R²⁺ 1 to 50% (where R²⁺ is at least one of Mg²⁺, Ca²⁺, Sr²⁺, Ba²⁺, Zn²⁺ and the value indicated on the left is a value obtained by adding their respective content ratios), and in anion %,

F⁻ 10 to 65%, and

O²⁻ 35 to 90%.

The reason why the contents (in cation %, in anion %) of the anion components and the cation components constituting the transparent substrate 110 are limited to the above-described ranges will be described below. Note that the “cation %” indicates the ratio (percentage) of the number of moles Mc1 of each cation component of the total number of moles Mc obtained by adding the numbers of moles of all of the cation components constituting the transparent substrate 110 (namely, (Mc1/Mc)×100). Similarly, the “anion %” indicates the ratio (percentage) of the number of moles Ma1 of each anion component of the total number of moles Ma obtained by adding the numbers of moles of all of the anion components constituting the transparent substrate 110 (namely, (Ma1/Ma)×100).

P⁵⁺ is a main component (a cation component made of glass forming oxide) forming glass, and is an essential component for improving the fracture toughness, improving the transmittance for the visible range, and increasing the cutting property for the near-infrared range. However, a ratio of P⁵⁺ of less than 20 cation % is not preferable because its effects cannot be sufficiently obtained. On the other hand, a ratio of P⁵⁺ of more than 45 cation % is not preferable because glass becomes unstable and thus increases in liquidus temperature and decreases in weather resistance. The ratio of P⁵⁺ is preferably 25 to 44 cation %, and more preferably 28 to 43 cation %.

Al³⁺ is an essential component for improving the fracture toughness and increasing the weather resistance. However, a ratio of Al³⁺ of less than 1 cation % is not preferable because its effects cannot be sufficiently obtained, and a ratio of Al³⁺ of more than 25 cation % is not preferable because glass becomes unstable and decreases in spectroscopic characteristics. The ratio of Al³⁺ is preferably 5 to 20 cation %, and more preferably 8 to 18 cation %. Note that it is more preferable to use, as the material of Al³⁺, AlF₃ or Al(PO₃)₃ than to use Al₂O₃ in that it is possible to prevent an increase in melting temperature and prevent occurrence of an unmelted substance and in that it is possible to ensure the charged amount of F⁻.

R⁺ is at least one of Li⁺, Na⁺, K⁺, and is an essential component for softening glass in order to decrease the melting temperature of glass. However, a ratio of R⁺ (a total ratio of Li⁺, Na⁺, K⁺) of less than 1 cation % is not preferable because its effects cannot be sufficiently obtained, and a ratio of R⁺ of more than 30 cation % is not preferable because glass becomes unstable and decreases in fracture toughness. The ratio of R⁺ is preferably 5 to 25 cation %, and more preferably 10 to 23 cation %.

Note that in R⁺, Na⁺ has a greater effect of improving the transmittance for the visible range than that of Li⁺ but also has a greater effect of decreasing the fracture toughness. The near-infrared cut filter glass is required to have a transmittance for the visible range as high as possible. For this end, setting the value of [Na⁺]/([Li⁺]+[Na⁺]) to a specific range in the glass makes it possible to increase both performances of the fracture toughness and the transmittance for the visible range. A value of [Na⁺]/([Li⁺]+[Na⁺]) of less than 0.02 is not preferable because the transmittance for the visible range is not sufficient, and a value of [Na⁺]/([Li⁺]+[Na⁺]) of more than 0.25 is not preferable because the fracture toughness decreases. The value of [Na⁺]/[Li⁺]+[Na⁺]) is preferably 0.03 to 0.15, and more preferably 0.05 to 0.1. Note that each of [Na⁺] and [Li⁺] in the above expression indicates the ratio (cation %) of each of Na⁺ and Li⁺ contained in all of the cation components.

Cu²⁺ is an essential component for cutting the near-infrared ray. However, a ratio of Cu²⁺ of less than 1 cation % is not preferable because its effects cannot be sufficiently obtained, and a ratio of Cu²⁺ of more than 15 cation % is not preferable because the transmittance for the visible range decreases. The ratio of Cu²⁺ is preferably 2 to 12 cation %, and more preferably 2.5 to 10 cation %.

R²⁺ is at least one of Mg²⁺, Ca²⁺, Sr²⁺, Ba²⁺, Zn²⁺, and is an essential component for increasing the fracture toughness of glass. However, a ratio of R²⁺ (a total ratio of Mg²⁺, Ca²⁺, Sr²⁺, Ba²⁺, Zn²⁺) of less than 1 cation % is not preferable because its effects cannot be sufficiently obtained, and a ratio of R²⁺ of more than 50 cation % is not preferable because glass becomes unstable. The ratio of R²⁺ is preferably 5 to 40 cation %, and more preferably 10 to 35 cation %.

Note that an investigation of the relationship between each cation component of alkaline earth metal and the fracture toughness of glass has shown that Mg²⁺, Ca²⁺, and Zn²⁺ have a greater effect of increasing the fracture toughness of glass than Sr²⁺, Ba²⁺. Setting the value of ([Mg²⁺]+[Ca²⁺]+[Zn²⁺])/([Mg²⁺]+[Ca²⁺]+[Sr²⁺]+[Ba²⁺]+[Zn²⁺]) to a specific range makes it possible to increase the fracture toughness of glass. A value of ([Mg²⁺]+[Ca²⁺]+[Zn²⁺])/([Mg²⁺]+[Ca²⁺]+[Sr²⁺]+[Ba²⁺]+[Zn²⁺]) of less than 0.50 is not preferable because the fracture toughness decreases, and a value of ([Mg²⁺]+[Ca²⁺]+[Zn²⁺])/([Mg²⁺]+[Ca²⁺]+[Sr²⁺]+[Ba²⁺]+[Zn²⁺]) of more than 0.80 is not preferable because glass becomes unstable. The value of ([Mg²⁺]+[Ca²⁺]+[Zn²⁺])/([Mg²⁺]+[Ca²⁺]+[Sr²⁺]+[Ba²⁺]+[Zn²⁺]) is preferably 0.55 to 0.75, and more preferably 0.60 to 0.70. Note that each of [Mg²⁺], [Ca²⁺], [Zn²⁺], [Sr²⁺], Ma1 in the above expression indicates the ratio (cation %) of each of Mg²⁺, Ca²⁺, Zn²⁺, Sr²⁺, Ba²⁺ in all of the cation components.

F⁻ is an essential component for stabilizing glass and for improving the weather resistance. However, a ratio of F⁻ of less than 10 anion % is not preferable because its effects cannot be sufficiently obtained, and a ratio of F⁻ of more than 65 anion % is not preferable because the transmittance for the visible range decreases. The ratio of F⁻ is preferably 15 to 60 anion %, and more preferably 20 to 55 anion %.

O²⁻ is an essential component for stabilizing glass. However, a ratio of O²⁻ of less than 35 anion % is not preferable because its effects cannot be sufficiently obtained, and a ratio of O²⁻ of more than 90 anion % is not preferable because glass becomes unstable. The ratio of O²⁻ is preferably 40 to 85 anion %, and more preferably 45 to 80 anion %.

Further, in the case of the phosphoric acid-based glass substrate, the transparent substrate 110 preferably contains, in mass %,

P₂O₅ 40 to 80%,

Al₂O₃ 1 to 20%,

R₂O 0.5 to 30% (where R₂O is at least one of Li₂O, Na₂O, K₂O, and the value indicated on the left is a value obtained by adding their respective content ratios),

CuO 1 to 8%, and

RO 0.5 to 40% (where RO is at least one of MgO, CaO, SrO, BaO, ZnO, and the value indicated on the left is a value obtained by adding their respective content ratios).

P₂O₅ is a main component (a glass forming oxide) forming glass, and is an essential component for improving the fracture toughness, improving the transmittance for the visible range, and increasing the cutting property for the near-infrared range. However, a ratio of P₂O₅ of less than 40 mass % in the whole transparent substrate 110 is not preferable because its effects cannot be sufficiently obtained, and a ratio of P₂O₅ of more than 80 mass % is not preferable because glass becomes unstable and thus increases in liquidus temperature and decreases in weather resistance. The ratio of P₂O₅ is preferably 42 to 75 mass % in the whole transparent substrate 110, and more preferably 45 to 70 mass %.

Al₂O₃ is an essential component for improving the fracture toughness and increasing the weather resistance. However, a ratio of Al₂O₃ of less than 1 mass % in the whole transparent substrate 110 is not preferable because its effects cannot be sufficiently obtained, and a ratio of Al₂O₃ of more than 20 mass % is not preferable because glass becomes unstable and decreases in spectral characteristics. The ratio of Al₂O₃ is preferably 3 to 18 mass % in the whole transparent substrate 110, and more preferably 6 to 16 mass %.

R₂O is at least one of Li₂O, Na₂O, K₂O, and is an essential component for decreasing the melting temperature of glass and softening glass. However, a ratio of R₂O (a total ratio of Li₂O, Na₂O, K₂O) of less than 0.5 mass % in the whole transparent substrate 110 is not preferable because its effects cannot be sufficiently obtained, and a ratio of R₂O of more than 30 mass % is not preferable because glass becomes unstable and decreases in fracture toughness. The ratio of R₂O is preferably 1 to 25 mass % in the whole transparent substrate 110, and more preferably 2 to 20 mass %.

CuO is an essential component for cutting the near-infrared ray. A ratio of CuO of less than 1 mass % in the whole transparent substrate 110 is not preferable because its effects cannot be sufficiently obtained, and a ratio of CuO of more than 8 mass % is not preferable because the transmittance for the visible range decreases. The ratio of CuO is preferably 3 to 8 mass % in the whole transparent substrate 110, and more preferably 4 to 7 mass %.

RO is at least one of MgO, CaO, SrO, BaO, ZnO, and is an essential component for increasing the fracture toughness of glass. However, a ratio of RO (a total ratio of MgO, CaO, SrO, BaO, ZnO) of less than 0.5 mass % in the whole transparent substrate 110 is not preferable because its effects are sufficiently, and when a ratio of RO of more than 40 mass % is not preferable because glass becomes unstable. The ratio of RO is preferably 1 to 35 mass % in the whole transparent substrate 110, and more preferably 2 to 30 mass %.

As other components, nitrate compound and sulfate compound can be added as an oxidant or a clarifying agent.

Setting the composition of the transparent substrate 110 within the above-described ranges makes it possible to obtain a transparent substrate 110 having a fracture toughness of 0.1 MPa·m^{1/2} to 0.74 MPa·m^{1/2}, an average thermal expansion coefficient in a temperature range of 50 to 300° C. of 65×10⁻⁷/K to 200×10⁻⁷/K, and a glass transition point (Tg) of 300° C. to 500° C.

(Optical Thin Film 120)

The optical thin film 120 is provided on the front surface 110A located on a side on which light is incident of the transparent substrate 110. The optical thin film 120 is an anti-reflection film and decreases the reflectance of light on the front surface 110A of the glass substrate 100 to increase the transmittance for light. The optical thin film 120 is composed, for example, of a single layer film formed of magnesium fluoride (MgF₂). Further, the optical thin film 120 may be composed of a film of three layers made by stacking a film of a mixture of aluminum oxide (Al₂O₃) and zirconium oxide (ZrO₂), a zirconium oxide (ZrO₂) film, and a magnesium fluoride (MgF₂) film in this order. In addition, the optical thin film 120 may be composed of an alternate multilayer film made by alternately stacking a silicon oxide (SiO₂) film and a titanium oxide (TiO₂) film. The single layer or multilayer film is formed on the front surface 110A of the transparent substrate 110 by a film forming method such as vacuum deposition, sputtering or the like. In addition, the optical thin film 120 may be formed as a coating film by applying a coating agent forming fine irregularities or a coating agent having a low refractive index on the surface of the transparent substrate 110.

(Optical Thin film 130)

The optical thin film 130 is provided, as a UVIR cut film that cuts an ultraviolet (UV) ray and an infrared (IR) ray, on the rear surface 110B of the transparent substrate 110. The optical thin film 130 is composed, for example, of a multilayer film made by alternately stacking a plurality of dielectric films different in refractive index such as a SiO₂ film, a TiO₂ film and the like. The multilayer film is formed on the rear surface 110B of the transparent substrate 110 by a film forming method such as vacuum deposition, sputtering or the like. Note that when the transparent substrate 110 can sufficiently absorb light in the near-infrared wavelength range, the optical thin film 130 may be configured not to cut the light in the near-infrared wavelength range but to cut the ultraviolet (UV) ray.

Note that the optical thin film 120 or the optical thin film 130 does not have to be formed on the front surface 110A or the rear surface 110B of the transparent substrate 110 when the transparent substrate 110 is bonded with another member or when they are unnecessary. Further, for the purpose of improving the near-infrared cutting performance of the glass substrate 100, a resin coat layer made by dispersing a near-infrared absorbent in a resin may be interposed between the transparent substrate 110 and the optical thin film 120 or between the transparent substrate 110 and the optical thin film 130.

(Glass Substrate Cutting Apparatus)

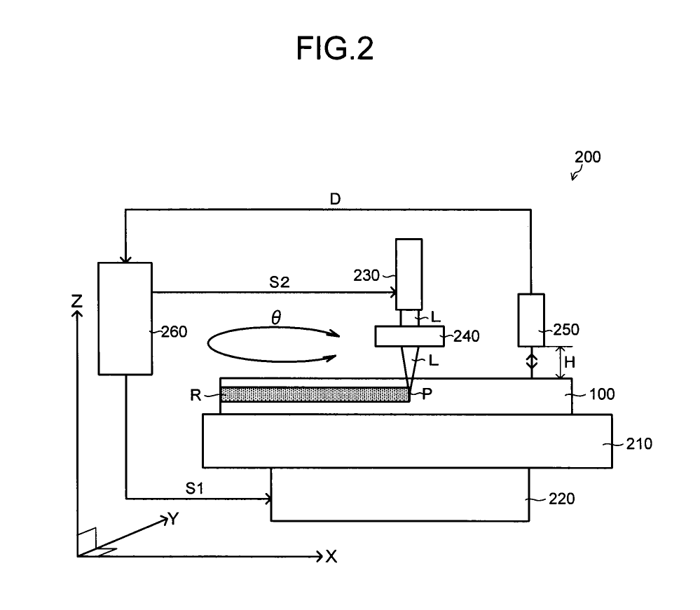

FIG. 2 is a schematic view of a glass substrate cutting apparatus 200 according to the embodiment. FIG. 2 illustrates a side view of the cutting apparatus 200. As illustrated in FIG. 2, the cutting apparatus 200 includes a table 210, a driving mechanism 220, a laser light irradiation mechanism 230, an optical system 240, a distance measuring system 250, and a control mechanism 260.

The table 210 is a table for allowing the glass substrate 100 being a cutting object to be mounted. The glass substrate 100 is mounted on the table 210 with the front surface 110A (see FIG. 1) side where the optical thin film 120 being an anti-reflection film is formed located on the upper side. Note that the table 210 is movable in each of an X-direction, a Y-direction, and a Z-direction as illustrated in FIG. 2. Further, the table 210 is rotatable in an rotation direction θ around the Z-direction as a rotation axis in an XY plane as illustrated in FIG. 2.

The driving mechanism 220 is coupled with the table 210 and moves, based on an instruction (control signal S1) outputted from the control mechanism 260, the table 210 in the horizontal directions (X-direction, Y-direction), the vertical direction (Z-direction), and the rotation direction (θ-direction).

The laser light irradiation mechanism 230 is a light source that radiates the laser light L on the basis of an instruction (control signal S2) outputted from the control mechanism 260. Note that it is preferable to use, for the light source of the laser light irradiation mechanism 230, a YAG laser. The YAG laser is preferable because it can provide a high laser intensity and is power-saving and relatively inexpensive. In addition, a publicly-known solid-state laser such as a titanium-sapphire laser or the like can also be used.

A center wavelength of the laser light L outputted from the YAG laser is 1064 nm. However, nonlinear optical crystals are used to generate harmonics and thereby can radiate laser light L having a center wavelength of 532 nm (green) or laser light L having a center wavelength of 355 nm (ultraviolet ray). Further, the center wavelength of the laser light L outputted from the titanium-sapphire laser is adjustable in a range of 650 to 1100 nm, and the center wavelength which can be most efficiently oscillated in the range is 800 nm. Further, nonlinear optical crystals are used to generate harmonics and thereby can also radiate laser light L having a center wavelength of, for example, 400 nm.

The laser light L only needs to have the center wavelength in a wavelength range transmitted through the transparent substrate 110, and preferably has a center wavelength of 380 nm to 800 nm. If the laser light L is out of the above-described wavelength range, the transmittance of the transparent substrate 110 decreases and may fail to efficiently utilize the output of the laser light L.

Further, in the case of using glass containing a copper component for the transparent substrate 110, the glass has a characteristic of absorbing the ultraviolet ray and the near-infrared ray. Therefore, it is preferable to use the laser light L having a center wavelength in 400 nm to 700 nm, in the case of cutting the glass substrate 100 including the transparent substrate 110 containing the copper component.

Note that it is preferable to use, for the laser light irradiation mechanism 230, the one capable of radiating pulsed laser light as the laser light L. Further, as the light source of the laser light L, a femtosecond laser, a picosecond laser, or a nanosecond laser may be used as long as it can radiate the pulsed laser light. Further, it is preferable to use a laser light irradiation mechanism 230 for which factors such as the wavelength, pulse width, repetition frequency, irradiation time, and energy intensity of the laser light L can be arbitrarily set according to the thickness (plate thickness) of the transparent substrate 110 and the size of the modified region R to be formed in the transparent substrate 110.

The pulse width of the laser light L is preferably 1 picosecond or more to 100 nanoseconds or less. When the pulse width of the laser light L is less than 1 picosecond, heat by the laser light L exerts less influence and therefore may fail to sufficiently form the modified region R. On the other hand, when the pulse width of the laser light L is more than 100 nanoseconds, the peak energy per pulse is small and therefore may fail to sufficiently form the modified region R.

The repetition frequency of the laser light L is preferably 1 kHz or more to 1 MHz or less. When the repetition frequency of the laser light L is less than 1 kHz, the formation speed of the modified region R is low and the productivity is low. On the other hand, when the repetition frequency of the laser light L is more than 1 MHz, the speed for moving the irradiation position of the laser light L needs to be increased, so that an expensive driving mechanism is necessary for coping with the speed and an error in positioning may increase.

The optical system 240 includes an optical lens OL (not illustrated), and converges the laser light L radiated from the laser light irradiation mechanism 230 to the inside of the transparent substrate 110. In other words, the optical system 240 forms a collecting point P inside the transparent substrate 110 to form the modified region R inside the transparent substrate 110.

The distance measuring system 250 is a laser distance meter and measures a distance H to the surface of the glass substrate 100, namely, the surface of the optical thin film 120 by a phase difference measurement method. The distance measuring system 250 measures the distance H between itself and the surface of the glass substrate 100 at predetermined time intervals (for example, every several milliseconds), and outputs distance information D to the control mechanism 260.

The control mechanism 260 controls the driving mechanism 220 to move the table 210 so that the laser light L is radiated from the laser light irradiation mechanism 230 along a cutting line (hereinafter, a planned cutting line) preset on the glass substrate 100. Further, the control mechanism 260 adjusts the height of the table 210 on the basis of the distance information D outputted from the distance measuring system 250.

More specifically, the control mechanism 260 controls the driving mechanism 220 to make the distance H between the optical system 240 and the glass substrate 100 fall within a fixed range (for example, ±5 μm) to thereby adjust the position of the glass substrate 100 in a height direction (Z-direction). Note that from the viewpoint of the strength of the glass substrate 100 after cutting, it is preferable to adjust the height of the glass substrate 100 so that the collecting point P of the laser light L is located at substantially the center in the thickness direction of the transparent substrate 110.

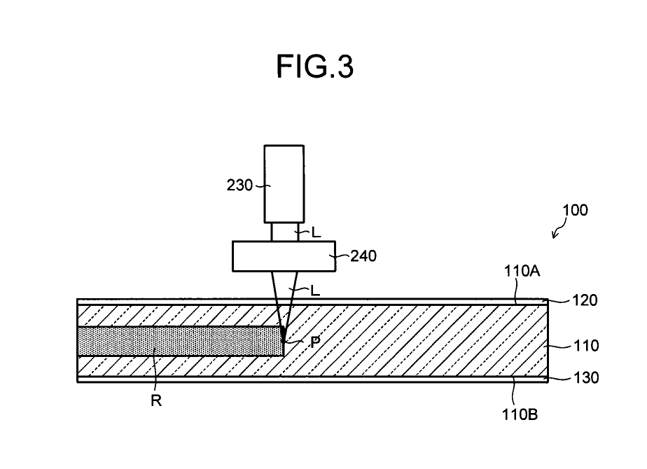

FIG. 3 is an explanatory view for explaining the appearance at the time of cutting the glass substrate 100. As illustrated in FIG. 3, preferably, the modified region R formed inside the transparent substrate 110 by irradiation with the laser light L does not reach at least one of the front surface 110A and the rear surface 110B of the transparent substrate 110.

(Cutting Method)

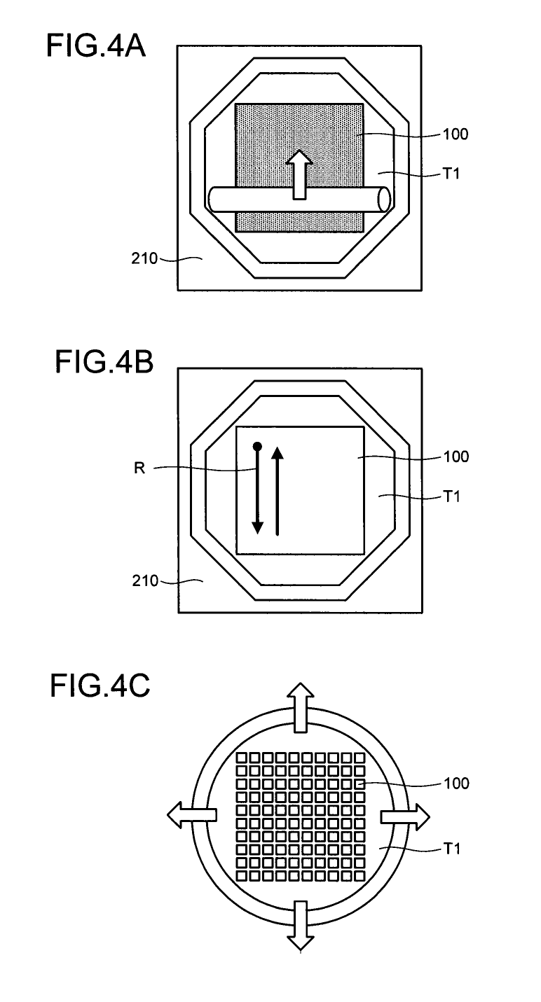

Hereinafter, a method for cutting the glass substrate 100 will be described in a manufacturing method for the glass substrate 100. FIG. 4A, FIG. 4B, FIG. 4C are explanatory views of the cutting method for the glass substrate 100. Hereinafter, the cutting method for the glass substrate 100 will be described referring to FIG. 4A, FIG. 4B, FIG. 4C.

First, the glass substrate 100 is bonded to a tape T1 for expansion with the front surface 110A (see FIG. 1) side where the optical thin film 120 (anti-reflection film) is provided located on the upper side, whereby the glass substrate 100 is mounted (see FIG. 4A) on the stage 210 of the cutting apparatus 200 (see FIG. 2). Note that one glass substrate 100 is bonded to the tape T1 in FIG. 4A, but the number of glass substrates 100 to be bonded to the tape T1 may be plural.

Next, the cutting apparatus 200 is used to radiate the laser light L to the glass substrate 100 along the planned cutting line from the front surface 110A side where the optical thin film (anti-reflection film) 120 is provided, to thereby form the modified region R (see FIG. 1) inside the glass substrate 100 (see FIG. 4B). Note that the modified region R may be formed by scanning with the laser light L a plurality of times along the planned cutting line. In other words, scanning with the laser light L may be performed a plurality of times along the planned cutting line with the collecting point P of the laser light L made different in the direction of the plate thickness of the glass substrate 100.

When the laser light L is radiated from the front surface 110A side where the optical thin film (anti-reflection film) 120 is provided in the glass substrate 100, the laser light L is unlikely to be reflected on the front surface 110A side of the glass substrate 100. This makes it possible to suppress a decrease in energy efficiency of the laser light L entering the inside of the glass substrate 100. As a result, a desired modified region R can be surely formed at a desired position inside the glass substrate 100.

Next, by expanding the tape T1 in arrow directions, a tensile cutting stress is applied to the glass substrate 100. Thus, the glass substrate 100 is cut into individual pieces along planned cutting lines starting from the modified region R formed in the glass substrate 100 (see FIG. 4C).

As described above, according to this embodiment, the transparent substrate 110 constituting the glass substrate 100 has a fracture toughness in a range of 0.1 MPa·m^{1/2} to 0.74 MPa·m^{1/2}. Therefore, cracks are likely to occur starting from the modified region R formed inside the transparent substrate 110 in this embodiment so that the glass substrate 100 can be easily cut. Further, by pulling the glass substrate 100 in a planar direction, the cracks occurring from the modified region R are likely to extend in the plate thickness direction of the glass substrate 100, thus making the cut surface of the glass substrate 100 unlikely to be rough and making it possible to obtain an excellent dimensional accuracy and a high bending strength.

The fracture toughness of the transparent substrate 110 is preferably 0.15 to 0.65 MPa·m^{1/2}, more preferably 0.2 to 0.6 MPa·m^{1/2}, and further more preferably 0.2 to 0.5 MPa·m^{1/2}.

Further, in this embodiment, the transparent substrate 110 constituting the glass substrate 100 has an average thermal expansion coefficient in a temperature range of 50 to 300° C. in a range of 65×10⁻⁷/K to 200×10⁻⁷/K and a glass transition point (Tg) in a range of 300° C. to 500° C. Therefore, the modified region R that become a starting point of cracks is likely to be formed inside the transparent substrate 110 by the laser light L. As a result, the modified region R being a starting point of the cracks can be easily formed along the desired planned cutting line. Further, the cracks are likely to occur from the modified region R, thus making the cut surface of the glass substrate 100 unlikely to be rough and making it possible to obtain an excellent dimensional accuracy and a high bending strength.

The average thermal expansion coefficient of the transparent substrate 110 in the temperature range of 50 to 300° C. is preferably 75×10⁻⁷/K to 180×10⁻⁷/K, more preferably 90×10⁻⁷/K to 150×10⁻⁷/K, and further more preferably 110×10⁻⁷/K to 140×10⁻⁷/K.

When a thin glass substrate having a plate thickness in a range of 0.10 mm to 1.00 mm is cut by the cutting method such as blade dicing or the like, flaw, chip and so on may occur starting from chipping or the like occurred at an end portion. However, the cutting method according to the embodiment of the present invention can cut with a smaller modified region R as the plate thickness of the glass substrate is smaller. Namely, the energy of laser to be radiated to the glass substrate can be made smaller. Therefore, as the plate thickness of the glass substrate is smaller, less chipping, cracks and so on occur at the end portion of the glass substrate due to cutting, so that a glass substrate with a high strength can be obtained, and the cutting method according to the embodiment of the present invention is preferable as the cutting method for the glass substrate in the above-described plate thickness range.

Note that in order to set the fracture toughness of the transparent substrate 110 constituting the glass substrate 100 within a range of 0.1 MPa·m^{1/2} to 0.74 MPa·m^{1/2}, set the average thermal expansion coefficient in a temperature range of 50 to 300° C. within a range of 65×10⁻⁷/K to 200×10⁻⁷/K, and set the glass transition point (Tg) within a range of 300° C. to 500° C., the composition is preferably set as follows.

Concretely, in the case of the fluorophosphoric acid-based glass substrate, the transparent substrate 110 preferably contains, in cation %,

P⁵⁺ 20 to 45%,

Al³⁺ 1 to 25%,

R⁺ 1 to 30% (where R⁺ is at least one of Li⁺, Na⁺, K⁺, and the value indicated on the left is a value obtained by adding their respective content ratios),

Cu²⁺ 1 to 15%, and

R²⁺ 1 to 50% (where R²⁺ is at least one of Mg²⁺, Ca²⁺, Sr²⁺, Ba²⁺, Zn²⁺ and the value indicated on the left is a value obtained by adding their respective content ratios), and in anion %,

F⁻ 10 to 65%, and

O²⁻ 35 to 90%.

Further, in the case of the phosphoric acid-based glass substrate, the transparent substrate 110 preferably contains, in mass %,

P₂O₅ 40 to 80%,

Al₂O₃ 1 to 20%,

R₂O 0.5 to 30% (where R₂O is at least one of Li₂O, Na₂O, K₂O, and the value indicated on the left is a value obtained by adding their respective content ratios),

CuO 1 to 8%, and

RO 0.5 to 40% (where RO is at least one of MgO, CaO, SrO, BaO, ZnO and the value indicated on the left is a value obtained by adding their respective content ratios).

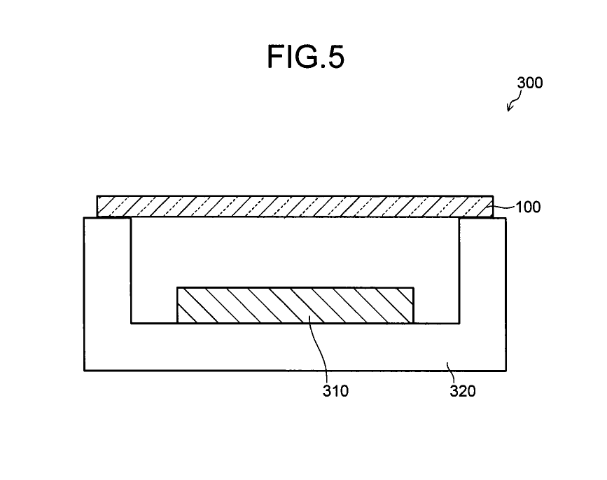

FIG. 5 is a cross-sectional view illustrating an example in which the glass substrate 100 cut as described above is used for an imaging apparatus 300. The imaging apparatus 300 is made by hermetically sealing the glass substrate 100 in this embodiment in a housing 320 which has a solid state imaging device 310 (for example, a CCD or a CMOS) built therein. Using the glass substrate 100 in this embodiment makes it possible to suppress the worry that flaws occur in the optical glass starting from the chipping and cracks occurred at the end portion. As a result, an imaging apparatus 300 with a high reliability can be provided.

### Working Examples

Hereinafter, working examples of the present invention will be describe in detail, but the present invention is not limited to the following working examples.

In Working Example (Example 3), fluorophosphoric acid glass (a plate thickness of 0.3 mm, dimensions of 100 mm×100 mm) was prepared as the glass substrate. In contrast to this, in Comparative Example (Example 10), non-alkali glass (aluminosilicate-based glass, a plate thickness of 0.3 mm, dimensions of 100 mm×100 mm) was prepared as the glass substrate. Note that the glass substrate prepared in Working Example is glass formed in the composition range described in the above embodiment.

Note that in Working Example and Comparative Example described below, no optical thin film was formed on the surface of the glass. In this case, the glass substrate and the transparent substrate are synonymous.

The fracture toughness of each glass substrate was 0.44 MPa·m^{1/2} in Working Example (Example 3) and 0.85 MPa·m^{1/2} in Comparative Example (Example 10). Further, the thermal expansion coefficient of each glass substrate was 129×10⁻⁷/K in Working Example (Example 3) and 38×10⁻⁷/K in Comparative Example (Example 10). Furthermore, the glass transition point of each glass substrate was 400° C. in Working Example (Example 3) and 690° C. in Comparative Example (Example 10).

The fracture toughness of the glass substrate is a value (K1c) calculated by the following expression in the Indentation Fracture method (IF method) defined by JIS R1607. Note that measurement of the fracture toughness of the glass substrate was performed using a Vickers hardness meter (manufactured by Future Tech Corp., ARS9000F, and analysis software: FT-026) under the environmental conditions that the room temperature was 23° C. and the humidity was about 30%. Further, in this measurement, a crack extends from an indentation formed by an indenter and grows with time. Therefore, the measurement of the crack length was performed within 30 seconds after the indenter was separated from the glass substrate.

K1c=0.026·E^{1/2}·P^{1/2}·a·C^{3/2}

In the above expression, E is a Young's modulus, P is an indentation load, a is ½ of the average of an indentation diagonal line length, and C is ½ of the average of the crack length. The thermal expansion coefficient of the glass substrate is an average value of values measured by a differential expression defined by JIS R3102 and measured at 50° C. to 300° C. Further, the glass transition point of the glass substrate is a value measured by TMA (thermomechanical analysis) in conformity with JIS R3103-3.

In Working Example and Comparative Example, the glass substrate was cut into a rectangular shape of 5 mm×5 mm under the following conditions.

For the step of selectively forming the modified region inside the glass substrate was performed under the following conditions. A YAG laser (with a central wavelength of 1064 nm) was used as the laser light source and modulated to make pulsed laser light with a central wavelength of 532 nm incident on the glass substrate. Further, the laser output was an output at such a level that the modified region did not reach the surface of the glass substrate, and appropriate energy was selected from a range of energy per pulse of 2 μJ to 20 μJ. The center of the modified region formed by the laser light was the central portion in the plate thickness direction of the glass substrate (for example, a position of 0.15 mm in the plate thickness direction from the glass surface in the case of a plate thickness of the glass substrate of 0.3 mm).

Then, the glass substrate having the modified region formed therein was subjected to a step of extending the crack occurring in the thickness direction of the glass substrate starting from the modified region and cutting the glass substrate along the modified region. In this step, the glass substrate having the modified region formed therein was bonded to an expansible resin film and the resin film was pulled in the planar direction of the glass substrate. By extending the crack occurring from the modified region of the glass substrate up to the surface of the glass substrate in this manner, the glass substrate was cut.

Then, the cutting property of each glass substrate was confirmed. More specifically, the case where 98% or more of the planned cutting line was cut in the step of cutting the glass substrate along the modified region was determined that the glass substrate was cut.

In Working Example (Example 3), the glass substrate could be cut by scanning of the planned cutting line with the laser light only one time. In contract, in Comparative Example (Example 10), the glass substrate could not be cut by scanning of the planned cutting line with the laser light only one time. Therefore, in Comparative Example (Example 10), it was confirmed whether or not the glass substrate could be cut while the number of times of scanning of the same point on the planned cutting line of the glass substrate with the laser light was increased by one. At the time of increasing the number of times of scanning with the laser light, control was performed to prevent the center of a precedently formed modified region by the scanning with the laser light and the center of a subsequently formed modified region from being located at the same position, by changing the scanning position with the laser light in the plate thickness direction of the glass substrate. As a result, in Comparative Example (Example 10), the glass substrate could be cut by scanning the same planned cutting line with the laser light seven times.

It is conceivable that, in Comparative Example (Example 10), the size of the crack occurring from the modified region formed by the laser light inside the glass substrate is small and the crack is unlikely to extend to the surface of the glass substrate in the step of cutting the glass substrate along the modified region. Therefore, it is conceivable that, in Comparative Example, the scanning of the same planned cutting line with the laser light a plurality of times was necessary as described above.

In contrast, in Working Example (Example 3), the size of the crack occurring from the modified region formed by the laser light inside the glass substrate is appropriately large and the crack is likely to extend to the surface of the glass substrate in the step of cutting the glass substrate along the modified region. Therefore, it is conceivable that, in Working Example, cutting could be reliably performed by the scanning of the same planned cutting line with the laser light one time as described above.

Table 1 and Table 2 list Working Examples (Example 1 to Example 8) where the cutting property was confirmed by the same method as described above for a plurality of glass substrates different in glass composition. In Table 1 and Table 2, Example 1 to Example 8 are Working Examples, and Example 9 and Example 10 are Comparative Examples.

In Table 1 and Table 2, glass composition, plate thickness, fracture toughness, average thermal expansion coefficient (in a temperature range of 50 to 300° C.), and glass transition point are listed for the glass substrates used in Example 1 to Example 10. Further, in Table 1 and Table 2, total input energy of laser light is indicated as the laser light condition at processing. As the total input energy of laser light, a relative value, when a value obtained by multiplying an output value per pulse (μJ/pulse) by the number of times of scanning in the case of Example 10 is 1, is indicated.

In addition, in Table 1 and Table 2, the strength of the glass substrate after cutting and the cutting property of the glass substrate are listed. As the strength of the glass substrate after cutting, a relative value, when an average value of a 4-point bending strength in the case of Example 10 is 1, is indicated. Further, as the cutting property of the glass substrate, the result obtained by confirming the minimum number of times of scanning with the laser light capable of cutting.

Note that, in Table 1 and Table 2, the composition (wt %, anion %, cation %) is indicated down to the first decimal place (down to the second decimal place for a component with small content). Further, a portion indicated with “-” in Table 1 and Table 2 means that it is unmeasured.

For the strength of the glass substrate after cutting, measurement was performed referring to the “4-point bending strength test” defined in JIS R 1601 (2008). Here, the test piece was a square shape of 5 mm×5 mm in size, and a fulcrum pitch was 3 mm, a load point pitch was 1 mm, and a radius of curvature of tips being the fulcrum and the load point in a support member was 0.25 mm. Further, the bending strength was measured in 16 plates for one condition, and their average value was indicated.

TABLE 1

| | Example 1 | Example 2 | Example 3 | Example 4 |
|---|---|---|---|---|
| Composition | Fluoro- | Fluoro- | Fluoro- | Fluoro- |
| System | phosphoric | phosphoric | phosphoric | phosphoric |
| | acid | acid | acid | acid |
| Composition | | | | |
| (wt %) | | | | |
| P₂O₅ | 54.0 | 26.1 | 41.6 | 41.6 |
| AlF₃ | 5.2 | 21.3 | 11.5 | 11.5 |
| CuO | 3.8 | 2.2 | 3.4 | 3.4 |
| MgF₂ | 10.5 | 6.1 | 3.0 | 3.0 |
| CaF₂ | 15.8 | 3.5 | 5.3 | 5.3 |
| BaF₂ | 3.6 | 13.0 | 15.0 | 15.0 |
| SrF₂ | 0.0 | 18.4 | 10.4 | 10.4 |
| LiF | 0.0 | 9.2 | 9.8 | 9.8 |
| NaF | 7.1 | 0.2 | 0.0 | 0.0 |
| Total | 100.0 | 100.0 | 100.0 | 100.0 |
| Plate thickness [mm] | 0.3 | 0.3 | 0.3 | 0.15 |
| Fracture toughness | 0.40 | 0.46 | 0.44 | 0.44 |
| [MPa · m^{1/2}] | | | | |
| Average thermal expansion | 81 | — | 129 | 129 |
| coefficient [×10⁻⁷/K] | | | | |
| Glass transition point [° C.] | 485 | — | 400 | 400 |
| Total input energy of laser | — | — | 0.15 | 0.04 |
| light | | | | |
| 4-point bending strength | — | — | 2.8 | 4.0 |
| (average value) | | | | |
| Cutting property (number | 1 time | 1 time | 1 time | 1 time |
| of times of scanning) | | | | |

| | | | Example 3 |
|---|---|---|---|
| | Example 1 | Example 2 | Example 4 |
| Composition | Fluoro- | Fluoro- | Fluoro- |
| System | phosphoric | phosphoric | phosphoric |
| | acid | acid | acid |
| Composition | | | |
| (cation %, anion %) | | | |
| P⁵⁺ | 47.6 | 26.8 | 41.0 |
| Al³⁺ | 3.9 | 18.5 | 9.5 |
| Li⁺ | 0.0 | 25.9 | 26.5 |
| Na⁺ | 10.5 | 0.4 | 0.0 |
| K⁺ | 10.4 | 0.0 | 0.0 |
| Mg²⁺ | 10.6 | 7.1 | 3.2 |
| Ca²⁺ | 12.7 | 3.2 | 4.7 |
| Sr²⁺ | 0.0 | 10.7 | 5.8 |
| Ba²⁺ | 1.3 | 5.4 | 6.2 |
| Cu²⁺ | 3.0 | 2.0 | 3.1 |
| Cation total | 100.0 | 100.0 | 100.0 |
| F− | 12.5 | 42.4 | 14.6 |
| O− | 87.5 | 57.6 | 85.4 |
| Anion total | 100.0 | 100.0 | 100.0 |

TABLE 2

| | Example 5 | Example 6 | Example 7 | Example 8 | Example 9 | Example 10 |
|---|---|---|---|---|---|---|
| Composition system | Phosphoric | Phosphoric | Phosphoric | Borosilicate | Soda lime | Non-alkali |
| | acid | acid | acid | | | |
| Composition (wt %) | | | | | | |
| P₂O₅ | 70.5 | 71.1 | 65.8 | 0.0 | 0.0 | 0.0 |
| Al₂O₃ | 8.2 | 13.0 | 14.9 | 4.5 | 1.1 | 17.0 |
| CuO | 7.9 | 4.1 | 5.5 | 0.0 | 0.0 | 0.0 |
| B₂O₃ | 1.3 | 0.0 | 0.0 | 8.5 | 0.0 | 8.0 |
| SiO₂ | 0.0 | 0.0 | 0.08 | 65.5 | 70.6 | 60.0 |
| MgO | 0.0 | 3.3 | 0.3 | 0.0 | 5.9 | 3.0 |
| CaO | 0.0 | 0.0 | 0.07 | 0.0 | 9.2 | 4.0 |
| BaO | 4.5 | 2.8 | 4.5 | 0.0 | 0.0 | 0.0 |
| SrO | 0.0 | 0.0 | 0.02 | 0.0 | 0.0 | 8.0 |
| ZnO | 0.0 | 1.4 | 4.0 | 8.1 | 0.0 | 0.0 |
| Li₂O | 0.0 | 0.0 | 0.0 | 0.0 | 0.0 | 0.0 |
| K₂O | 0.0 | 4.3 | 4.8 | 6.7 | 0.7 | 0.0 |
| Na₂O | 7.6 | 0.0 | 0.0 | 6.7 | 12.5 | 0.0 |
| F₂O₃ | 0.0 | 0.0 | 0.02 | 0.02 | 0.0 | 0.0 |
| SO₃ | 0.0 | 0.0 | 0.05 | 0.0 | 0.0 | 0.0 |
| Total | 100.0 | 100.0 | 100.0 | 100.0 | 100.0 | 100.0 |
| Plate thickness [mm] | 0.3 | 0.3 | 0.3 | 0.3 | 0.3 | 0.3 |
| Fracture toughness [MPa · m^{1/2}] | 0.54 | 0.61 | 0.58 | 0.67 | 0.75 | 0.85 |
| Average thermal expansion coefficient [×10⁻⁷/K] | 99 | 81 | 79 | 72 | 85 | 38 |
| Glass transition point [° C.] | 470 | 485 | 530 | 557 | 555 | 690 |
| Total input energy of laser light | 0.25 | — | — | 0.75 | 0.70 | 1.00 |
| 4-point bending strength (average value) | 2.0 | — | — | 1.6 | — | 1.00 |
| Cutting property (number of times of scanning) | 1 time | 2 times | 1 time | 3 times | 6 times | 7 times |

As listed in Table 1 and Table 2, the fracture toughness falls within a range of 0.1 MPa·m^{1/2} to 0.74 MPa·m^{1/2} or the average thermal expansion coefficient in a temperature range of 50 to 300° C. falls within a range of 65×10⁻⁷/K to 200×10⁻⁷/K in Example 1 to Example 8. In Example 1 to Example 8, the glass substrate can be cut by scanning the planned cuffing line with the laser light one time to three times.

In particular, in Example 1 to Example 4, fluorophosphoric acid glass with a lower fracture toughness and a larger average thermal expansion coefficient than those of other examples is used as the glass substrate, so that the glass substrate can be cut by scanning the planned cutting line with the laser light one time with a low total input energy of laser light.

Further, in Example 3 to Example 5, the fracture toughness is lower and the average thermal expansion coefficient is larger than those of Comparative Examples, so that the total input energy of laser light can be decreased and the number of times of scanning with the laser light can be reduced. Therefore, the crack and chipping remaining at the end surface of the glass substrate are made small, thus making it possible to obtain a glass substrate with a high bending strength. It is generally known that glass with a larger fracture toughness has a larger bending strength. However, by using the cutting method of the present invention, such a specific result can be obtained that glass with a lower fracture toughness results in a higher bending strength of the glass substrate after cutting.

As listed in Table 1 and Table 2, in each of Example 1 to Example 8, it is possible to obtain a glass substrate which can be easily cut and has a high bending strength by efficiently forming the modified region in the glass substrate.

A cutting method for a glass substrate of the present invention is preferably used for a usage in which a plate thickness is as small as 0.10 mm to 1.00 mm and a bending stress is applied (for example, optical glass such as a cover glass, a near-infrared cut filter and the like used in solid state imaging devices (CCD and CMOS) of a digital still camera and the like.

What is claimed is:

1. A cutting method for a glass substrate, comprising the steps of:
radiating light to be focused inside a glass substrate having a fracture toughness of 0.1 MPa·m^{1/2} to 0.74 MPa·m^{1/2} to selectively form a modified region inside the glass substrate; and
causing a crack in a thickness direction of the glass substrate starting from the modified region and cutting the glass substrate along the modified region.

2. The cutting method for a glass substrate according to claim 1,
wherein the fracture toughness of the glass substrate is 0.2 MPa·m^{1/2} to 0.74 MPa·m^{1/2}.

3. A cutting method for a glass substrate, comprising the steps of:
radiating light to be focused inside a glass substrate having an average thermal expansion coefficient in a temperature range of 50 to 300° C. of 65×10⁻⁷/K to 200×10⁻⁷/K to selectively form a modified region inside the glass substrate; and
causing a crack in a thickness direction of the glass substrate starting from the modified region and cutting the glass substrate along the modified region.

4. The cutting method for a glass substrate according to claim 1,
wherein the glass substrate has an average thermal expansion coefficient in a temperature range of 50 to 300° C. of 75×10⁻⁷/K to 150×10⁻⁷/K and a glass transition point (Tg) of 300° C. to 500° C.

5. The cutting method for a glass substrate according to claim 1,
wherein, in the step of cutting the glass substrate, an expansible film is bonded to the glass substrate, then the film is expanded in a planar direction with respect to the glass substrate to cause the crack in the thickness direction of the glass substrate starting from the modified region and cut the glass substrate along the modified region.

6. A glass substrate including a cut surface cut along a modified region selectively formed therein by light radiated to be focused therein and having a fracture toughness of 0.1 MPa·m^{1/2} to 0.74 MPa·m^{1/2}.

7. The glass substrate according to claim 6,
wherein the fracture toughness is 0.2 MPa·m^{1/2} to 0.74 MPa·m^{1/2}.

8. A glass substrate including a cut surface cut along a modified region selectively formed therein by light radiated to be focused therein and having an average thermal expansion coefficient in a temperature range of 50 to 300° C. of 65×10⁻⁷/K to 200×10⁻⁷/K.

9. The glass substrate according to claim 6,
wherein the average thermal expansion coefficient in the temperature range of 50 to 300° C. is 75×10⁻⁷/K to 150×10⁻⁷/K, and the glass transition point (Tg) is 300° C. to 500° C.

10. The glass substrate according to claim 6 containing,
in cation %,
P⁵⁺ 20 to 45%,
Al³⁺ 1 to 25%,
R⁺ 1 to 30% (where R⁺ is at least one of Li⁺, Na⁺, K⁺, and the value indicated on the left is a value obtained by adding their respective content ratios),
Cu²⁺ 1 to 15%, and
R²⁺ 1 to 50% (where R²⁺ is at least one of Mg²⁺, Ca²⁺, Sr²⁺, Ba²⁺, Zn²⁺ and the value indicated on the left is a value obtained by adding their respective content ratios), and in anion %,
F⁻ 10 to 65%, and
O²⁻ 35 to 90%.

11. The glass substrate according to claim 6 containing,
in mass %,
P₂O₅ 40 to 80%,
Al₂O₃ 1 to 20%,
R₂O 0.5 to 30% (where R₂O is at least one of Li₂O, Na₂O, K₂O, and the value indicated on the left is a value obtained by adding their respective content ratios),
CuO 1 to 8%, and
RO 0.5 to 40% (where RO is at least one of MgO, CaO, SrO, BaO, ZnO and the value indicated on the left is a value obtained by adding their respective content ratios).

12. The glass substrate according to claim 6,
wherein an optical thin film is provided on a surface thereof.

13. The glass substrate according to claim 6,
wherein a plate thickness thereof is 0.10 mm to 1.00 mm.

14. A near-infrared cut filter glass comprising the glass substrate according to claim 6.

15. A manufacturing method for a glass substrate, comprising:
radiating light to be focused inside a glass substrate having a fracture toughness of 0.1 MPa·m^{1/2} to 0.74 MPa·m^{1/2} to selectively form a modified region inside the glass substrate; and
causing a crack in a thickness direction of the glass substrate starting from the modified region and cutting the glass substrate along the modified region.

16. A manufacturing method for a glass substrate, comprising the steps of:
radiating light to be focused inside a glass substrate having an average thermal expansion coefficient in a temperature range of 50 to 300° C. of 65×10⁻⁷/K to 200×10⁻⁷/K to selectively form a modified region inside the glass substrate; and
causing a crack in a thickness direction of the glass substrate starting from the modified region and cutting the glass substrate along the modified region.
